(19) United States
(12) Patent Application Publication
(10) Pub. No.: US 2013/0161891 A1
(43) Pub. Date: Jun. 27, 2013

(54) DIE ATTACH APPARATUS

(71) Applicants: Min KIM, Cheonan-si (KR); Yon-mook PARK, Suwon-si (KR); Ki-seok SEO, Asan-si (KR); Young-hong HAN, Cheonan-si (KR)

(72) Inventors: Min KIM, Cheonan-si (KR); Yon-mook PARK, Suwon-si (KR); Ki-seok SEO, Asan-si (KR); Young-hong HAN, Cheonan-si (KR)

(21) Appl. No.: 13/614,118

(22) Filed: Sep. 13, 2012

(30) Foreign Application Priority Data
Dec. 27, 2011 (KR) 10-2011-0143920

(51) Int. Cl. B23Q 3/00

(52) U.S. Cl. 269/289 R

(57) ABSTRACT

A die attach apparatus includes a stage, a collet member that is movable to apply load to the stage, a load measuring member that is arranged between the collet member and the stage and that measures load between the collet member and the stage, the load measuring member is divided into a plurality of loading measuring regions and the plurality of load measuring regions measure loads within the plurality of load measuring regions, respectively, and a controller member that determines whether the collet member is in a tilted state or a non-tilted state based on the loads measured within the plurality of load measuring regions by the load measuring member.

### CROSS-REFERENCE TO RELATED APPLICATION

This application claims the priority under 35 U.S.C. §119 to Korean Patent Application No. 10-2011-0143920, filed on Dec. 27, 2011, in the Korean Intellectual Property Office, the disclosure of which is incorporated herein in its entirety by reference.

### BACKGROUND

Dies separated from a wafer are attached to a package substrate to perform a package process for forming a semiconductor package.

### SUMMARY

Embodiments may be realized by providing a die attach apparatus that includes a stage, a collet member that is movable to apply load to the stage, a load measuring member that is arranged between the collet member and the stage and that measures load between the collet member and the stage, the load measuring member is divided into a plurality of loading measuring regions, and the plurality of load measuring regions measure loads within the plurality of load measuring regions, respectively, and a controller member that determines whether the collet member is in a tilted state or a non-tilted state based on the loads measured within the plurality of load measuring regions by the load measuring member.

The load measuring member may include a base member having a variable resistance according to the loads within the plurality of load measuring regions, one or more first electrodes arranged on the base member, and one or more second electrodes arranged on the base member to correspond to the one or more first electrodes. Each of the load measuring regions may include at least one of the one or more first electrodes and at least one of the one or more second electrodes that are correspondingly arranged.

One of the one or more first electrodes may be arranged to correspond to one of the one or more second electrodes. One of the one or more first electrodes may be arranged to correspond to a plurality of the second electrodes. One or more first electrodes may be arranged around the one or more second electrodes. One or more second electrodes may be arranged around the one or more first electrodes.

Each of the load measuring regions may include a plurality of the second electrodes that are arranged to correspond to a single first electrode of the one or more first electrodes. One or more first electrodes may be a single first electrode having a one-body structure. The single first electrode may be arranged around the one or more second electrodes and may surround the one or more second electrodes. The single first electrode may be arranged between the one or more second electrodes.

A reference voltage may be applied to the one or more first electrodes. A measurement voltage may be applied to the one or more second electrodes. The controller member may compare the loads measured within the plurality of load measuring regions to each other. The load measuring member may be inserted into a groove in the collet member.

Embodiments may also be realized by providing a die attach apparatus including a stage, a collet member that is movable to apply load to the stage, a load measuring member that is disposed on the stage and that measures load between the collet member and the stage, the load measuring member is divided into a plurality of load measuring regions, the plurality of load measuring regions measure loads within the plurality of load measuring regions, respectively, and a controller member that determines whether the collet member is in a tilted state or a non-tilted state based on the loads measured within the plurality of load measuring regions by the load measuring member.

Embodiments may further be realized by providing a die attach apparatus that includes a stage, a collet member capable of applying load to the stage, a load measuring member that is housed within the collet member and that measures load between the collet member and the stage, the load measuring member is divided into a plurality of loading measuring regions such that each of the load measuring regions individually measures a load therein, and a controller member that determines whether the collet member is in a tilted state or a non-tilted state based on the load measured in each of the load measuring regions.

Each of the load measuring regions may be separately connected to the controller member through at least one electrode. Each of the load measuring regions may include a first electrode and a second electrode. The first electrode may extend across two or more of the load measuring regions and may be connected to the controller member through a first wiring. An entirety of the second electrode may be one of the load measuring regions and may be connected to the controller member through a second wiring.

The first electrode may be arranged spaced apart from the second electrode and may at least partially enclose the second electrode. The controller member may determine that the collet member is in the non-tilted state when the load measured in each of the load measuring regions is within a predetermined range.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic diagram of a die attach apparatus according to an exemplary embodiment;

FIGS. 2 and 3 illustrate plan views of a load measuring member of the die attach apparatus of FIG. 1, according to exemplary embodiments;

FIGS. 4 and 5 illustrate graphs for describing load measured by the load measuring member of FIG. 2, according to an exemplary embodiment

FIGS. 6 through 14 illustrate cross-sectional views of load measuring members that are obtained by modifying the load measuring member of FIG. 1, according to exemplary embodiments;

FIG. 15 illustrates a schematic diagram of a die attach apparatus according to an exemplary embodiment; and

FIG. 16 illustrates a plan view of a load measuring member of the die attach apparatus of FIG. 15, according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, steps, operations, elements, and/or components, but do not preclude the presence or addition of one or more other features, steps, operations, elements, components, and/or groups thereof.

Exemplary embodiments are described herein with reference to cross-sectional illustrations that are schematic illustrations of exemplary embodiments (and intermediate structures). As such, variations from the shapes of the illustrations as a result, e.g., of manufacturing techniques and/or tolerances, are to be expected. Thus, exemplary embodiments should not be construed as limited to the particular shapes of regions illustrated herein but may be to include deviations in shapes that result, for example, from manufacturing.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

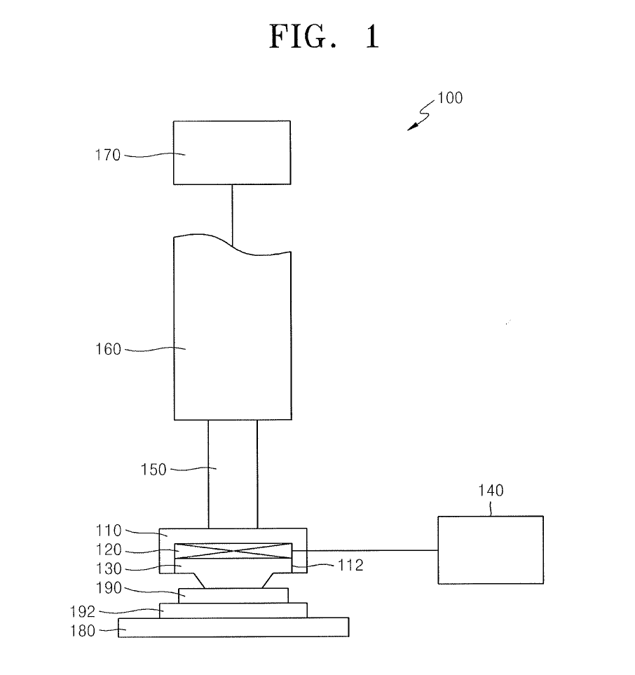

FIG. 1 is a schematic diagram of a die attach apparatus 100 according to an exemplary embodiment.

Referring to FIG. 1, the die attach apparatus 100 may include a collet member 110, a load measuring member 120, and an adsorption member 130. A controller member 140, a shaft member 150, a mount head member 160, and a main body member 170 may be included in the die attach apparatus 100. A stage 180 may be arranged to hold a die within the die attach apparatus 100. The above-described elements may be formed of metal, for example, stainless steel, aluminum, or the like.

The die attach apparatus 100 may separate a semiconductor die 190 from a wafer and may pressurize the semiconductor die 190 on a package substrate 192 disposed on the stage 180 to attach the semiconductor die 190 to the package substrate 192. Elements of the die attach apparatus 100 may be aligned such that the semiconductor die 190 may be attached to the package substrate 192 so as not to be tilted or so as to be only slightly titled, e.g., so as to be substantially parallel to the package substrate 192.

The die attach apparatus 100 may include the mount head member 160 coupled to the main body member 170 and the shaft member 150 coupled to the mount head member 160. The main body member 170 may include a moving member (not shown) and may horizontally and/or vertically move the mount head member 160 by the moving member.

The collet member 110 may be coupled to the shaft member 150 opposite to the mount head member 160. The collet member 110 may be horizontally and/or vertically moved according to the movement of the mount head member 160. The collet member 110 may be moved so as to apply load toward the stage 180. Accordingly, the semiconductor die 190 positioned on the stage 180 may be attached, by having pressure applying thereto, to the package substrate 192. The collet member 110 may include a groove 112 that faces the stage 180. The load measuring member 120 and/or the adsorption member 130 may be inserted into the groove 112. For example, that the load measuring member 120 and an upper portion of the adsorption member 130 may be housed within the groove 112 of the collet member 110.

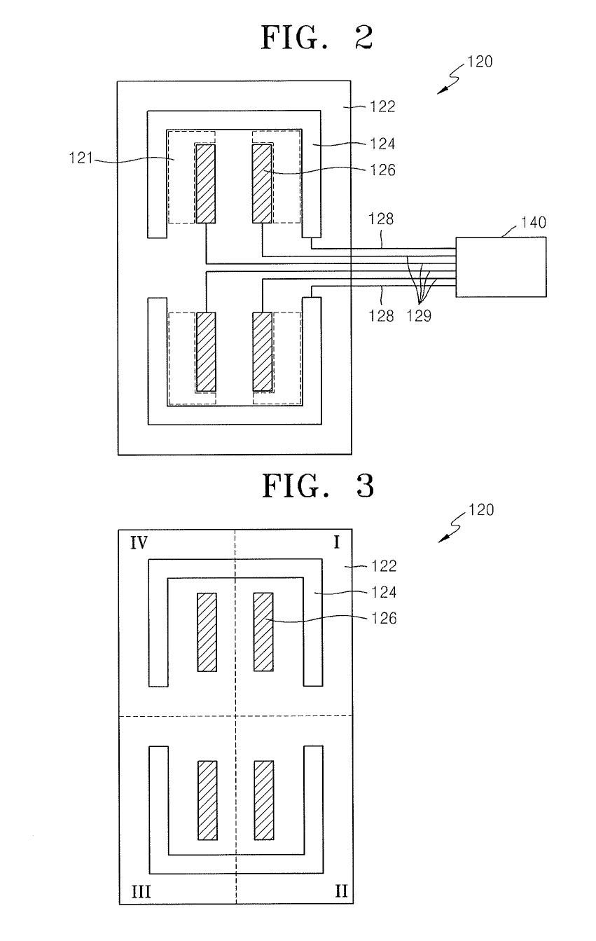

The load measuring member 120 may measure load between the collet member 110 and the stage 180. The load measuring member 120 may be divided into a plurality of load measuring regions. The loads may be individually measured in the respective load measuring regions. The load measuring member 120 will be described with reference to FIGS. 2 through 5.

The adsorption member 130 may attach to and/or adsorb the semiconductor die 190 so as to separate the semiconductor die 190 from the wafer (not shown) and to then move the semiconductor die 190 onto the stage 180. The adsorption member 130 may attach to and/or adsorb the semiconductor die 190 by using, e.g., a vacuum. The adsorption member 130 may include a rigid material such as metal, or a flexible material such as a polymer and rubber.

The controller member 140 may be electrically connected to the load measuring member 120 and may determine whether the collet member 110 is tilted, e.g., is in a tilted state, based on the load between the collet member 110 and the stage 180, which load is measured by the load measuring member 120. For example, the load measuring member 120 may include a plurality of load measuring regions, and the controller member 140 may compare loads that are respectively measured in the load measuring regions by the load measuring member 120. In addition, if one or a plurality of the determined loads are outside a predetermined range, it may be determined that die attach failure occurs and thus it may be determined that the collet member 110 is tilted. The determination may be indicated using a display device. When it is determined that the collet member 110 is tilted, a correction process may be performed, e.g., the collet member 110 may be aligned.

FIGS. 2 and 3 are plan views of the load measuring member 120 of the die attach apparatus 100 of FIG. 1, according to exemplary embodiments. In FIG. 3, it is noted that first wirings 128 and second wirings 129 are not shown.

Referring to FIG. 2, the load measuring member 120 may include a base member 122, one or more first electrodes 124, and one or more second electrodes 126. The first electrodes 124 may be spaced apart from the second electrodes 126.

The base member 122 may include a material of which resistance varies according to an applied load, e.g., the material may be a carbon film. The first electrodes 124 may be disposed on a first portion of the base member 122. The second electrodes 126 may be disposed on a second portion of the base member 122 so as to correspond to the placement of the first electrodes 124. For example, each first electrode 124 may partially surround at least one second electrode 126.

Referring to FIG. 2, the first electrode 124 may have a base portion elongated along a first direction on the base member 122 and two projection portions extending from opposing ends of the base portion. The two projection portions may be elongated along a second direction on the base member 122, which second direction may be substantially perpendicular to the first direction. At least one second electrode 126 may be spaced apart from the first electrode 124 and arranged parallel to the two projection portions of the first electrode 124. For example, two second electrodes 126 may be arranged entirely between the two projections of the first electrode 124

The first electrodes 124 may be electrically connected to the controller member 140 via the first wirings 128 and the second electrodes 126 may be electrically connected to the controller member 140 via second wirings 129. A reference voltage may be applied to the first electrodes 124 and a measurement voltage may be applied to the second electrodes 126. For example, 0V may be applied to the first electrodes 124 and a positive voltage or a negative voltage may be applied to the second electrodes 126.

Thus, an electrical signal value of regions 121, i.e., regions between and/or directly between the first electrodes 124 and the second electrodes 126, may be measured. The electrical signal value may be resistance value and/or may be related to load that is applied to the stage 180 (refer to FIG. 1) by the collet member 110 (refer to FIG. 1). For example, the load measuring member 120 may be a load cell.

For example, when the collet member 110 (refer to FIG. 1) is spaced apart from the stage 180 (refer to FIG. 1), a predetermined reference resistance value may be measured in the region 121 between the first electrodes 124 and the second electrodes 126. Then, when the collet member 110 (refer to FIG. 1) applies load on the stage 180 (refer to FIG. 1), a resistance value may be measured in the region 121 between the first electrodes 124 and the second electrodes 126. A difference between the reference resistance value and the measured resistance value is related to load, e.g., related to the load that the collet member 110 applies on the stage 180.

Referring to FIG. 3, the load measuring member 120 may be divided into a plurality of load measuring regions, e.g., into load measuring regions I, II, III, and IV. The load measuring member 120 may be divided into the load measuring regions I, II, III, and IV to have uniform areas. FIG. 3 shows four regions, that is, the load measuring regions I, II, III, and IV are shown. However, FIG. 3 is for the purpose of describing particular embodiments, and thus embodiments are not limited to FIG. 3. For example, embodiments may include more than four load measuring regions, different arrangements of the load measuring regions, etc. The load measuring regions I, II, III, and IV of the load measuring member 120 may respectively measure loads, e.g., only measure loads within that load measuring region.

Since the load measuring regions I, II, III, and IV may have uniform areas, total load may be uniformly distributed among the load measuring regions I, II, III, and IV. For example, when it is assumed that the total load is 100%, four loads each of which is about 25% of the total load may be respectively applied to the load measuring regions I, II, III, and IV. Accordingly, the semiconductor die 190 may not be seriously tilted, e.g., may be substantially flat so as to be substantially parallel with respect to the package substrate 192, and may be installed on the stage 180. Further, the collet member 110 may be determined to be in a non-titled state so that it applies substantially uniform load to the semiconductor die 190.

Each of the load measuring regions I, II, III, and IV includes the first electrodes 124 and the second electrodes 126 that are arranged to correspond to each other. According to the present embodiment, the first electrodes 124 extend over two regions from among the load measuring regions I, II, III, and IV, e.g., so as to be shared by two or more of the load measuring regions I, II, III, and IV. Each of the second electrodes 126 may be respectively disposed in one of the load measuring regions I, II, III, and IV, e.g., so that each of the load measuring regions I, II, III, and IV includes an entirety of one of the second electrodes 126. In other words, each of the second electrodes 126 are positioned entirely within one of the load measuring regions I, II, III, and IV.

One of the first electrodes 124 may be disposed to correspond to a plurality of second electrodes 126. For example, one of the first electrodes 124 may be disposed to correspond to two second electrodes 126. In addition, the first electrode 124 may be disposed around the second electrodes 126. For example, the second electrodes 126 may be disposed between the first electrodes 124.

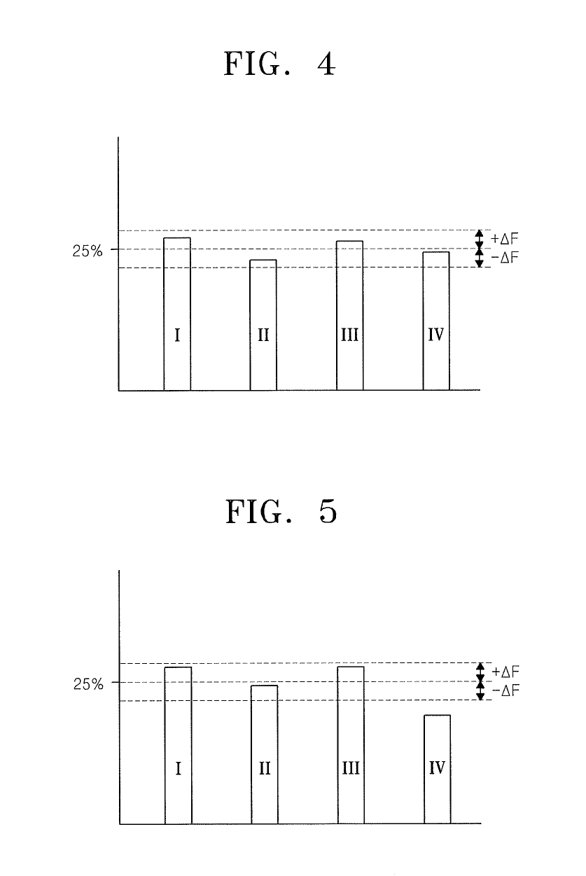

FIGS. 4 and 5 are graphs for describing load measured by the load measuring member 120 of FIG. 2, according to exemplary embodiments.

FIGS. 4 and 5 show loads measured by the load measuring regions I, II, III, and IV of the load measuring member 120. If it is assumed that total load is 100%, when uniform loads are exerted on the load measuring regions I, II, III, and IV, load of about 25% of the total load is exerted on each of the load measuring regions I, II, III, and IV. However, constant tolerance may be allowable and is indicted by ±ΔF in FIGS. 4 and 5.

In FIG. 4, load measured from each of the load measuring regions I, II, III, and IV has a value contained within 25%±ΔF. This means that the semiconductor die 190 is slightly tilted when installed on the stage 180. Since the measured load is contained in an allowable range, it is determined that die attach failure does not occur. Further, it may be determined that the collet member 110 is in a non-tilted state so that the collet member 110 may not be adjusted. The allowable range may be changed in various ways.

In FIG. 5, load measured from each of the load measuring regions I, II, III, and IV has a value contained within 25%±ΔF but load measured from the load measuring region IV has a value outside 25%±ΔF. This means that the semiconductor die 190 is seriously tilted when installed on the stage 180. Since the measured load is outside the allowable range, it is determined that die attach failure occurs. Further, it may be determined that the collet member 110 is in a tilted state so that the collet member 110 may be adjusted and/or that a tilt of the collet member 110 should be adjusted to accommodate the tilt of the semiconductor die 190.

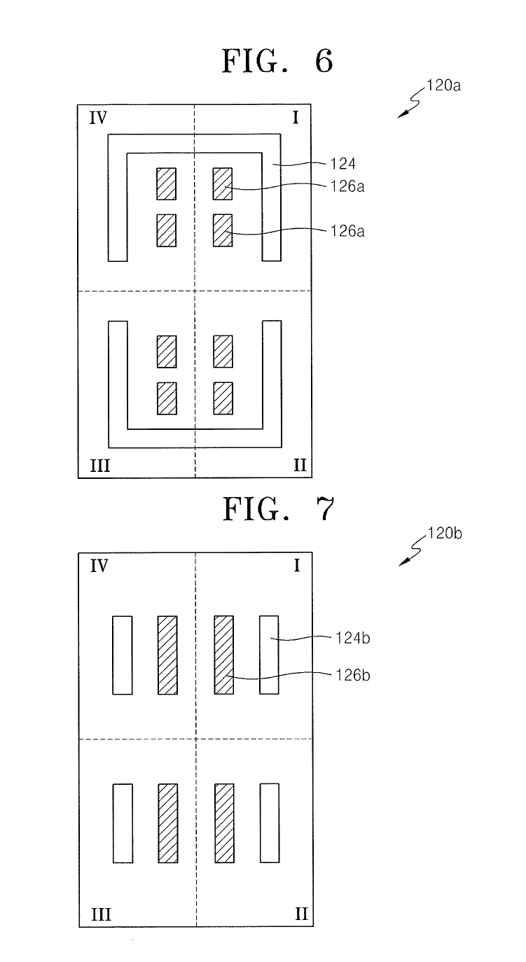

FIGS. 6 through 14 are cross-sectional views of load measuring members 120a, 120b, 120c, 120d, 120e, 120f, 120g, 120h, and 120i that are obtained by modifying the load measuring member 120 of FIG. 1, according to other various exemplary embodiments.

Referring to FIG. 6, the load measuring member 120a includes the first electrodes 124 and second electrodes 126a that are correspondingly arranged. The first electrodes 124 may extend over two regions from among the load measuring regions I, II, III, and IV. For example, each of the first electrodes 124 may have a part of the base portion and one projection portion in each of the load measuring regions I, II, III, and IV. Two of the second electrodes 126a may be disposed on each of the load measuring regions I, II, III, and IV. Two second electrodes 126a may be arranged in one region from among the load measuring regions I, II, III, and IV. Accordingly, four of the second electrodes 126a may be entirely arranged between projection portions of one of the first electrodes 124.

Average load may be obtained by taking an average of load measured between the first electrode 124 and two second electrodes 126a. The first electrodes 124 may be disposed around the second electrodes 126a. For example, the second electrodes 126a may be disposed between the first electrodes 124.

Referring to FIG. 7, the load measuring member 120b includes first electrodes 124b and second electrodes 126b that are correspondingly arranged. According to the present embodiment, a single first electrode 124b and a single second electrode 126b may be arranged in each of the load measuring regions I, II, III, and IV. The first electrodes 124b may be disposed around the second electrodes 126b. For example, the second electrodes 126b may be disposed between the first electrodes 124b with respect to the load measuring regions I and IV and with respect to load measuring regions II and III.

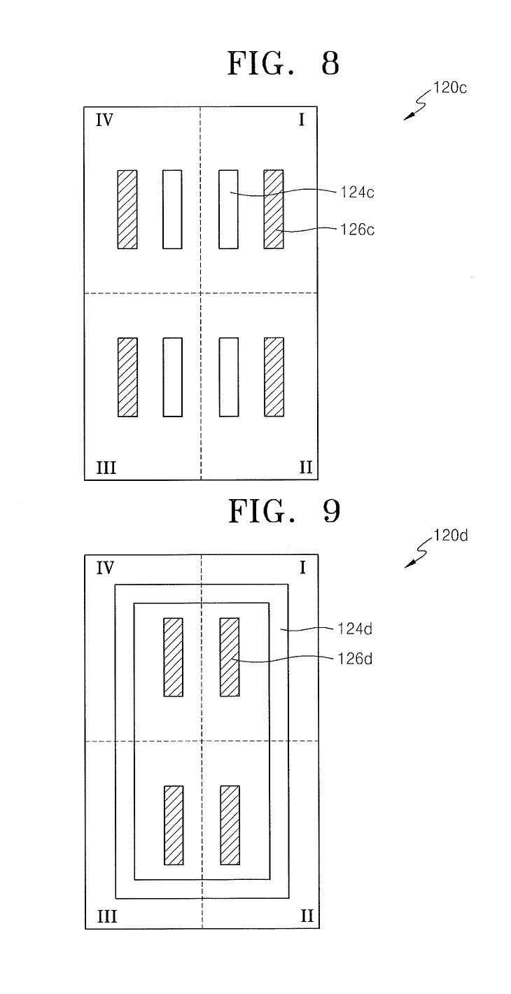

Referring to FIG. 8, the load measuring member 120c includes first electrodes 124c and second electrodes 126c that are correspondingly arranged. According to the present embodiment, a single first electrode 124c and a single second electrode 126c may be disposed in each of the load measuring regions I, II, III, and IV. The second electrodes 126c may be disposed around the first electrodes 124c. For example, the first electrodes 124c may be disposed between the second electrodes 126c with respect to the load measuring regions I and IV and with respect to load measuring regions II and III.

Referring to FIG. 9, the load measuring member 120d includes a first electrode 124d and second electrodes 126d that are correspondingly arranged. According to the present embodiment, the first electrode 124d extends over the load measuring regions I, II, III, and IV as a single first electrode 124d. Further, a single second electrode 126d is disposed in each of the load measuring regions I, II, III, and IV. The first electrode 124d may be a one-body continuous structure that encloses each of the second electrodes 126d therebetween. For example, the first electrode 124d may be disposed around the second electrodes 126d.

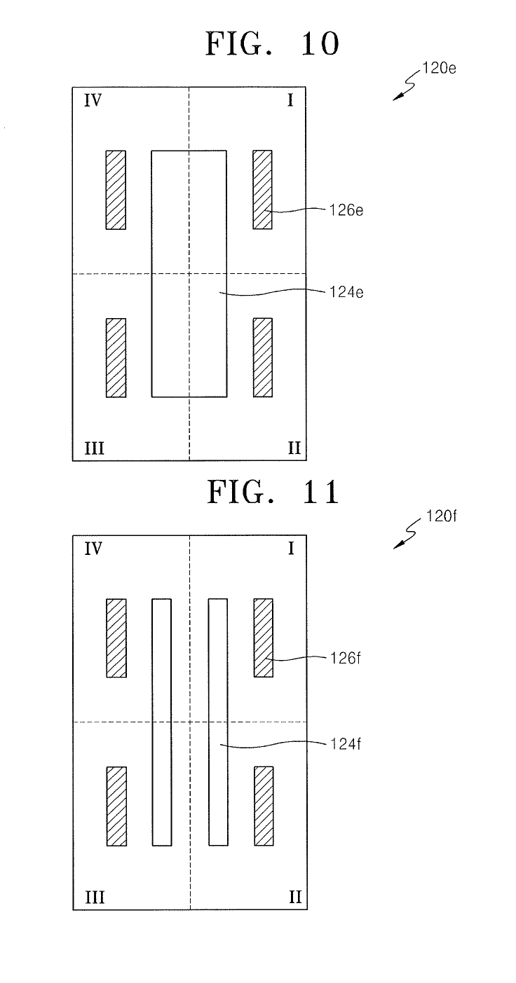

Referring to FIG. 10, the load measuring member 120e includes a first electrode 124e and second electrodes 126e that are correspondingly arranged. According to the present embodiment, the first electrode 124e extends over all of the load measuring regions I, II, III, and IV and is disposed on a central portion of the load measuring regions I, II, III, and IV. A single second electrode 126e is disposed in each of the load measuring regions I, II, III, and IV. The first electrode 124e may be a one-body continuous structure. End portions of the second electrodes 126e may be aligned, e.g., along a horizontal direction, with end portions of the first electrode 124e. The second electrodes 126e may be disposed around the first electrode 124e. For example, the first electrode 124e may be disposed between the second electrodes 126e.

Referring to FIG. 11, the load measuring member 120f includes first electrodes 124f and second electrodes 126f that are correspondingly arranged. According to the present embodiment, a plurality of first electrodes 124f extend over two regions from among the load measuring regions I, II, III, and IV and are disposed in a central portion of the load measuring regions I, II, III, and IV, and a single second electrode 126f is disposed in each of the load measuring regions I, II, III, and IV. The second electrodes 126f may be disposed around the first electrodes 124f. For example, the first electrodes 124f may be disposed between the second electrodes 126f. End portions of the second electrodes 126f may be aligned, e.g., along a horizontal direction, with end portions of the first electrodes 124f.

Referring to FIG. 12, the load measuring member 120g includes a first electrode 124g and second electrodes 126g that are correspondingly arranged. According to the present embodiment, the first electrode 124g extends over the load measuring regions I, II, III, and IV and is disposed in a central portion of the load measuring regions I, II, III, and IV. A triangular section of the first electrode 124g may be in each of the load measuring regions I, II, III, and IV. A single second electrode 126g may be disposed in each of the load measuring regions I, II, III, and IV. The second electrode 126g may be arranged at a diagonal within each of the load measuring regions I, II, III, and IV.

The second electrodes 126g may be arranged around the first electrode 124g, e.g., each second electrode 126g may be substantially parallel to different sides of the first electrode 124g. For example, the first electrode 124g may be disposed between the second electrodes 126g in each of the load measuring regions I, II, III, and IV. The second electrodes 126g may be diagonally disposed with respect to the first electrode 124g.

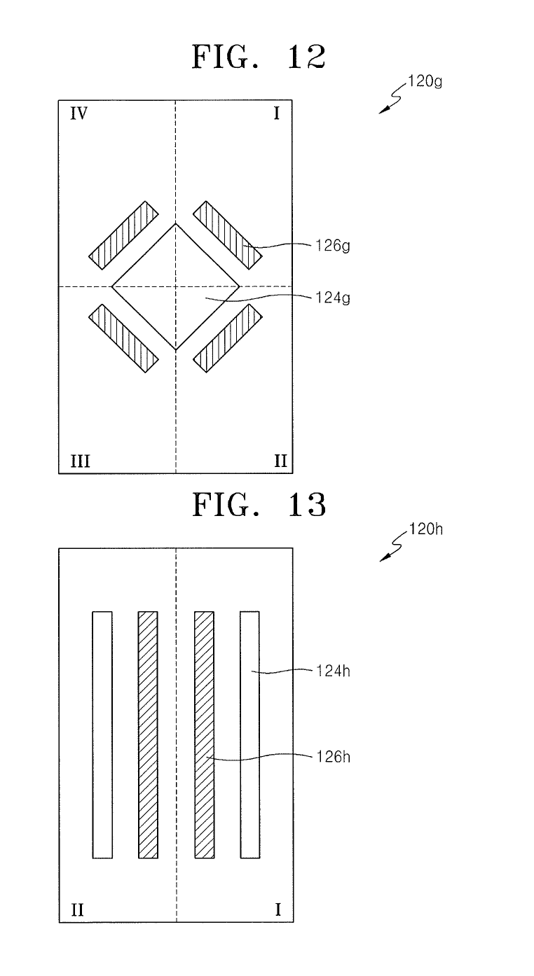

Referring to FIG. 13, the load measuring member 120h may be divided into two regions, that is, load measuring regions I and II. The load measuring member 120h may include first electrodes 124h and second electrodes 126h that are correspondingly arranged. According to the present embodiment, a single first electrode 124h and a single second electrode 126h are disposed in each of the load measuring regions I and II. In this case, respective loads may be measured in two regions so as to measure a tilt degree of the collet member 110 (refer to FIG. 1) in the right and left directions. In addition, the arrangement obtained by rotating the first electrodes 124h and second electrodes 126h by 90 degrees belongs to the technical feature of the exemplary embodiment.

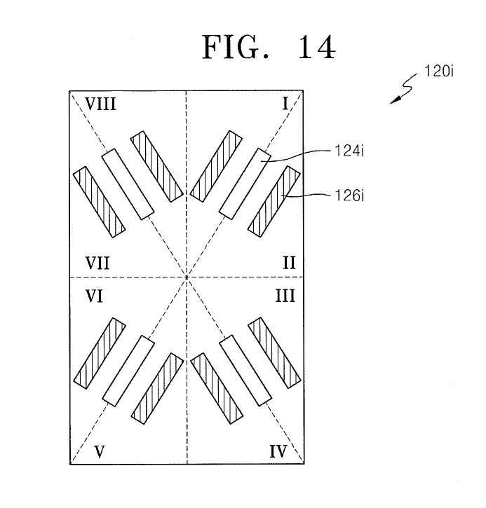

Referring to FIG. 14, the load measuring member 120i may be divided into eight regions, that is, load measuring regions I, II, III, IV, V, VI, VII, and VIII. The load measuring member 120i includes first electrodes 124i and second electrodes 126i that are correspondingly arranged. According to the present embodiment, a single first electrode 124i is disposed over two regions of the load measuring regions I, II, III, IV, V, VI, VII, and VIII and one of the second electrodes 126i are disposed in each of the load measuring regions I, II, III, IV, V, VI, VII, and VIII. In this case, respective loads may be measured in the load measuring regions I, II, III, IV, V, VI, VII, and VIII so as to measure a tilt degree of the collet member 110 (refer to FIG. 1) in eight directions. Each of first electrodes 124i and the second electrodes 126i may be arranged parallel to a dividing direction of the load measuring regions I, II, III, IV, V, VI, VII, and VIII.

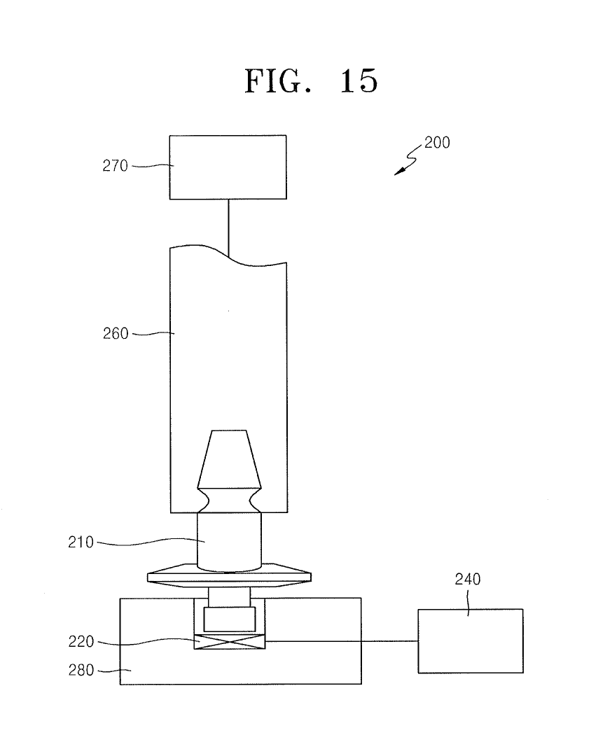

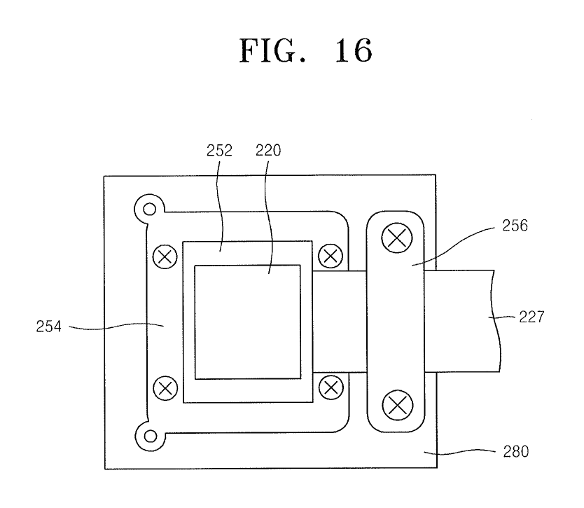

FIG. 15 is a schematic diagram of a die attach apparatus 200 according to another exemplary embodiment. FIG. 16 is a plan view of a load measuring member 220 of the die attach apparatus 200 of FIG. 15, according to another exemplary embodiment.

Referring to FIG. 15, the die attach apparatus 200 includes a collet member 210, the load measuring member 220, a controller member 240, a mount head member 260, a main body member 270, and a stage 280. The above-described elements may be formed of metal, e.g., stainless steel, aluminum, or the like. The die attach apparatus 200 may be a flip-chip bonding apparatus.

The die attach apparatus 200 may hold a semiconductor die (not shown) from a wafer and may pressurize the semiconductor die onto a package substrate (not shown) disposed on the stage 280 to attach the semiconductor die to the package substrate. Elements of the die attach apparatus 200 may be aligned, e.g., in a non-tilted state, such that the semiconductor die may be attached to the package substrate so as not to be tilted or not to be seriously titled.

The die attach apparatus 200 may include the mount head member 260 coupled to the main body member 270 and the collet member 210 coupled to the mount head member 260. The main body member 270 may include a moving member (not shown) and may horizontally and/or vertically move the mount head member 260 via the moving member.

The collet member 210 may be horizontally and/or vertically moved according to the movement of the mount head member 260. The collet member 210 may be moved so as to apply load to the stage 280.

The load measuring member 220 may be disposed on the stage 280 and may measure load between the collet member 210 and the stage 280. The load measuring member 220 may be divided into a plurality of load measuring regions. The load measuring regions may respectively measure loads. The load measuring member 220 may correspond to one of the load measuring members 120, 120a, 120b, 120c, 120d, 120e, 120f, 120g, 120h, and 120i, according to exemplary embodiments.

The controller member 240 may be electrically connected to the load measuring member 220 and may determine whether the collet member 210 is tilted, based on the load between the collet member 210 and the stage 280, which is measured by the load measuring member 220.

Referring to FIG. 16, the load measuring member 220 may be disposed on the stage 280 by coupling members 252 and 254. The load measuring member 220 may be electrically connected to the controller member 240 (refer to FIG. 15) via through a cable 227. The cable 227 may include the first and second wirings 128 and 129 shown in FIG. 2. The cable 227 may be disposed on the stage 280 by a cable coupling member 256.

By way of summation and review, semiconductor dies may be attached to package substrates in such a way in order to avoid being tilted, e.g., to avoid using a die attach apparatus that is in a tilted state. For a thin wafer, warping of the wafer may occur and the die is more likely to be tilted, e.g., in a non-aligned relationship, with respect to a printed circuit board (PCB) during a die attach process. In order to obtain a die that is substantially parallel to the PCB so as to be sufficiently horizontal with respect to the PCB, a tilt of a collet of the die attach apparatus may be corrected.

Coupling failures, damage, and the tilt of the collet, and a change in a length and angle of the collet may be visually determined by using pressure sensitive paper. However, it is difficult to determine whether failures occur and to establish standardization for determining whether failures occur. Further the pressure sensitive paper technique may be performed at a high cost and may be time consuming.

There is a need for improved accuracy of a die attach apparatus. More specifically, embodiments relate to a semiconductor package manufacturing apparatus and to a die attach apparatus for attaching a die to a substrate that determines whether a collet is in a tilted state or a non-tilted state. For example, embodiments relate to a die attach apparatus including a pressure sensor. It is determined whether a collet is tilted by inserting a load sensor into the collet or positioning the pressure sensor on a die support so as to measure load applied from the collet to a die.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A die attach apparatus, comprising:
a stage;
a collet member that is movable to apply load to the stage;
a load measuring member that is arranged between the collet member and the stage and that measures load between the collet member and the stage, the load measuring member being divided into a plurality of loading measuring regions, and the plurality of load measuring regions measure loads within the plurality of load measuring regions, respectively; and
a controller member that determines whether the collet member is in a tilted state or a non-tilted state based on the loads measured within the plurality of load measuring regions by the load measuring member.

2. The die attach apparatus of claim 1, wherein the load measuring member includes:
a base member having a variable resistance according to the loads within the plurality of load measuring regions;
one or more first electrodes arranged on the base member; and
one or more second electrodes arranged on the base member to correspond to the one or more first electrodes.

3. The die attach apparatus of claim 2, wherein each of the load measuring regions includes at least one of the one or more first electrodes and at least one of the one or more second electrodes that are correspondingly arranged.

4. The die attach apparatus of claim 2, wherein one of the one or more first electrodes is arranged to correspond to one of the one or more second electrodes.

5. The die attach apparatus of claim 2, wherein one of the one or more first electrodes is arranged to correspond to a plurality of the second electrodes.

6. The die attach apparatus of claim 2, wherein the one or more first electrodes are arranged around the one or more second electrodes.

7. The die attach apparatus of claim 2, wherein the one or more second electrodes are arranged around the one or more first electrodes.

8. The die attach apparatus of claim 2, wherein each of the load measuring regions includes a plurality of the second electrodes that are arranged to correspond to a single first electrode of the one or more first electrodes.

9. The die attach apparatus of claim 2, wherein the one or more first electrodes is a single first electrode having a one-body structure.

10. The die attach apparatus of claim 9, wherein the single first electrode is arranged around the one or more second electrodes and surrounds the one or more second electrodes.

11. The die attach apparatus of claim 9, wherein the single first electrode is arranged between the one or more second electrodes.

12. The die attach apparatus of claim 2, wherein:
a reference voltage is applied to the one or more first electrodes, and
a measurement voltage is applied to the one or more second electrodes.

13. The die attach apparatus of claim 1, wherein the controller member compares the loads measured within the plurality of load measuring regions to each other.

14. The die attach apparatus of claim 1, wherein the load measuring member is inserted into a groove in the collet member.

15. A die attach apparatus, comprising:
a stage;
a collet member that is movable to apply load to the stage;
a load measuring member that is disposed on the stage and that measures load between the collet member and the stage, the load measuring member being divided into a plurality of load measuring regions, and the plurality of load measuring regions measure loads within the plurality of load measuring regions, respectively; and
a controller member that determines whether the collet member is in a tilted state or a non-tilted state based on the loads measured within the plurality of load measuring regions by the load measuring member.

16. A die attach apparatus, comprising:
a stage;
a collet member capable of applying load to the stage;
a load measuring member that is housed within the collet member and that measures load between the collet member and the stage, the load measuring member being divided into a plurality of loading measuring regions such that each of the load measuring regions individually measures a load therein; and
a controller member that determines whether the collet member is in a tilted state or a non-tilted state based on the load measured in each of the load measuring regions.

17. The die attach apparatus of claim 16, wherein each of the load measuring regions is separately connected to the controller member through at least one electrode.

18. The die attach apparatus of claim 16, wherein each of the load measuring regions includes a first electrode and a second electrode, the first electrode extending across two or more of the load measuring regions and being connected to the controller member through a first wiring, and an entirety of the second electrode being one of the load measuring regions and being connected to the controller member through a second wiring.

19. The die attach apparatus of claim 18, wherein the first electrode is arranged spaced apart from the second electrode and at least partially encloses the second electrode.

20. The die attach apparatus of claim 16, wherein the controller member determines that the collet member is in the non-tilted state when the load measured in each of the load measuring regions is within a predetermined range.
